(19) United States
(12) Patent Application Publication
(10) Pub. No.: US 2026/0117577 A1
(43) Pub. Date: Apr. 30, 2026

(54) HOLLOW CHAMBER PROFILE FOR A WINDOW OR DOOR AND FRAME ASSEMBLY COMPRISING THE SAME

(71) Applicant: REHAU INDUSTRIES SE & CO. KG, Rehau (DE)

(72) Inventor: Horst TIPPENHAUER, Rehau (DE)

(21) Appl. No.: 19/375,072

(22) Filed: Oct. 30, 2025

(30) Foreign Application Priority Data
Oct. 30, 2024 (DE) 10 2024 131 909.7

(51) Int. Cl. E06B 3/22; E06B 3/263

(52) U.S. Cl. CPC E06B 3/22; E06B 3/263

(57) ABSTRACT

The present invention relates to a hollow chamber profile (2) for a window or door made of a plastic material, wherein the plastic material forms the inner walls (4, 4′, 4″) and the outer walls (5, 5′, 5″, 5′″) of the hollow chamber profile (1), wherein the inner walls (3, 3′, 3″) and the outer walls (4, 4′, 4″) surround the hollow chambers (3, 3′, 3″, 3′″) of the hollow chamber profile (1), wherein at least one insulation element (13) designed as a plastic profile is inserted into at least one of the hollow chambers (3″) of the hollow chamber profile (1), the surface of which is provided at least in some areas with a coating designed as a low-emission metal layer, wherein the hollow chamber profile (2) according to the invention is characterized in that the coating of the insulation element (13) has a plurality of interruptions. In addition, the present invention relates to a frame assembly (1) for a window or door, which comprises at least one profile section of a hollow chamber profile (2) according to the invention.

### CROSS REFERENCE TO RELATED APPLICATIONS

This application claims the benefit of, and priority, to German application DE 10 2024 131 909.7 filed on Oct. 30, 2024, the contents of which are incorporated herein by reference in their entirety.

### FIELD OF THE INVENTION

The present invention relates to a hollow chamber profile for a window or door made of plastic material, wherein the plastic material forms the inner walls and outer walls of the hollow chamber profile, wherein the inner walls and outer walls surround the hollow chambers of the hollow chamber profile, wherein at least one insulation element formed as a plastic profile is inserted into at least one of the hollow chambers of the hollow chamber profile, the surface of which is provided, at least in some areas, with a coating formed as a low-emission metal layer. Furthermore, the present invention relates to a frame assembly for a window or door, which comprises at least one profile section of such a hollow chamber profile.

### BACKGROUND OF THE INVENTION

Hollow chamber profiles for a window or door are produced in particular from thermoplastic plastic material and are used extensively in the manufacture of plastic windows and plastic doors. These profiles are predominantly manufactured by extrusion from rigid PVC (PVC-U). They usually have several hollow chambers that are separated from each other by internal webs. By arranging a number of hollow chambers one behind the other in the direction of heat transfer through the profile, i.e., from the room-side outer wall to the weather-side outer wall, a high level of thermal insulation is achieved in such plastic windows and plastic doors.

However, increasing the number of chambers arranged in series in the profile in the direction of heat transfer has reached its limits, so that only a slight further improvement in the thermal insulation achieved by a corresponding plastic window or plastic door can be achieved in this way. In addition, the number of internal webs also increases the material requirement of such a hollow chamber profile. Ultimately, the number of internal webs also limits the speed at which such a hollow chamber profile can be extruded, because the required heat dissipation from a hollow chamber profile with a correspondingly high number of internal webs increases the requirements for cooling capacity and cooling time after extrusion.

In this regard, WO 2011/1513061 A1 proposes inserting insulation elements, referred to as infrared radiation barriers, into the chambers of the hollow chamber profile. Such infrared radiation barriers further improve the thermal insulation properties of your hollow chamber profile. However, further improvement of the thermal insulation properties is desired.

### SUMMARY OF THE INVENTION

This is where the present invention comes in, the underlying task of which is to provide a hollow chamber profile for a window or door that at least partially overcomes the disadvantages of the prior art. In particular, the hollow chamber profile for a window or door according to the invention is intended to provide further improved thermal insulation properties. In addition, the task of the present invention is to provide a frame assembly for a window or door comprising at least one profile section of such a hollow chamber profile.

These and other tasks are solved by the invention by means of a hollow chamber profile with the features of claim 1 or by means of a frame assembly with the features of claim 9. Preferred embodiments of the present invention are described in the dependent claims.

According to the present invention, it has been recognized that part of the heat loss through the hollow chamber profile is due to the insulation element itself, in particular to its lateral thermal conductivity. According to the invention, this is reduced by the fact that the surface of the insulation element, which is at least in some areas coated with a low-emissivity metal layer, has a plurality of interruptions. The interruptions in the coating can be formed in the coating itself or by interruptions in the insulation element itself. The interruptions interrupt the heat flow along the coating, reducing its thermal conductivity, in particular its lateral thermal conductivity. As a result, the hollow chamber profile according to the invention has improved overall thermal conductivity.

Accordingly, the present invention provides a hollow chamber profile for a window or door made of a plastic material, wherein the plastic forms the inner walls and the outer walls of the hollow chamber profile, wherein the inner walls (and the outer walls) surround the hollow chambers of the hollow chamber profile, wherein at least one insulation element formed as a plastic profile is inserted into at least one of the hollow chambers of the hollow chamber profile, the surface of which is provided at least in some areas with a coating formed as a low-emission metal layer, wherein the hollow chamber profile according to the invention is further characterized in that the coating of the insulation element has a plurality of interruptions. Furthermore, the present invention also provides a frame assembly for a window or door, which comprises at least one profile section of a hollow chamber profile according to the invention.

By inserting an insulation element, the surface of which is provided at least in some areas with a coating formed as a low-emissivity metal layer, into one of the hollow chambers of the hollow chamber profile, the heat transfer through such a hollow chamber profile is significantly reduced. Such a coating formed as a low-emissivity metal layer can be designed as a metal layer applied to at least one side. Such an insulation element has a high degree of transmission in the visible range of the electromagnetic spectrum and high reflectivity in the infrared spectral range, and thus has low emissivity (“low E”). Accordingly, such an insulation element has the effect of reducing the emissivity in the wavelength range from 3 μm to 50 μm, particularly in the range of the maximum thermal radiation at room temperature (approximately 10 μm). As a result, the insulation element acts as a good reflector for thermal radiation at room temperature and can be used effectively in hollow chamber profiles to improve thermal insulation. For this purpose, a metal layer, for example an aluminum, silver, gold, and/or copper layer, is applied to at least one side of the insulation element to generate high reflectivity in the infrared spectral range. The metal layer can have a thickness in the range of 5 nm to 200 μm, preferably in the range of 10 nm to 80 nm, and particularly preferably in the range of 35 nm to 60 nm. The metal layers are preferably coated with a protective layer (in particular with an antioxidant effect), a decorative layer, a color layer, a lacquer layer, a functional layer, and combinations of the aforementioned layers in one or more layers. This allows a good thermal insulation effect of the hollow chamber profile to be achieved with a not too high number of hollow chambers. In addition, if the number of hollow chambers into which such an insulation element is inserted is not too high, the amount of material used is moderate. The insulation element or elements are inserted, in particular pushed in, into the corresponding hollow chambers after the hollow chamber profile has been extruded.

With regard to the hollow chamber profile according to the invention, it can be helpful if the interruptions are formed as perforations in the coating of the insulation element. Such perforations in the coating of the insulation element are easy to make and can be distributed evenly over the insulation element. Preferably, the perforations penetrate the coating of the insulation element completely. In particular, the perforations penetrate the entire insulation element completely.

With regard to the perforations in the coating, it may be useful if these have a diameter within a range of 0.05 mm to 0.8 mm, preferably within a range of 0.2 mm to 0.6 mm. If the perforations have a diameter within such a range, the lateral thermal conductivity is significantly reduced without the reflective properties of the coating being overly impaired due to the interruption. From this point of view, it is particularly preferable for the perforations in the coating to have a diameter of approximately 0.4 mm.

In addition or as an alternative, it may also prove advantageous if the coating has perforations at a frequency within a range of 2 to 30 per cm² of the coating, in particular within a range of 5 to 20 per cm² of the coating. Here too, frequencies within one of the aforementioned ranges have proven to be particularly advantageous in terms of achieving a balance between reduced lateral thermal conductivity and the reflective properties of the coating.

In order to be able to insert the insulation element or elements into the corresponding hollow chambers after extrusion of the hollow chamber profile, in particular to be able to push them in, and to ensure the desired position of the insulation element or elements and thus their optimum insulating effect, it is preferable for at least one of the inner walls of the hollow chamber(s) into which the at least one insulation element is inserted to have at least one positioning element for positioning the at least one insulation element. Such a positioning element ensures that the at least one insulation element can be easily inserted into the corresponding hollow chamber of the hollow chamber profile and remains in a defined position in the hollow chamber after insertion, so that its maximum achievable insulation effect is maintained during processing (welding of the hollow chamber profiles, transport, etc.) and, above all, afterwards during its use in a window or door. In addition, the positioning element helps to compensate for manufacturing tolerances of the hollow chamber profile and the at least one insulation element. This makes a technical and economic contribution to the assembly of hollow chamber profiles in bar form according to the invention.

It can be particularly advantageous if the hollow chamber profile comprises at least two positioning elements arranged on two opposite inner walls of the hollow chamber in which the at least one insulation element is accommodated. In this way, the at least one insulation element is held in a clamping manner in the intended hollow chamber of the hollow chamber profile according to the invention, thereby further increasing the positional stability of the at least one positioning element in the hollow chamber profile according to the invention. For this purpose, the at least one insulation element may be slightly oversized in comparison to the hollow chamber dimensions. This increases the clamping effect. The positioning elements may be designed independently of one another as angular or round recesses in the profile walls or as such recesses in raised areas of the hollow chamber profile according to the invention. It is also possible for the positioning elements to be formed independently of one another in the corners as angular or round recesses, i.e., as recesses in two adjacent profile walls of the hollow chamber profile according to the invention.

It may also be advantageous if the at least one insulation element is inserted into the main hollow chamber of the hollow chamber profile. The main hollow chamber of a hollow chamber profile is the hollow chamber into which the reinforcing element or reinforcement element is usually inserted. This main hollow chamber is therefore usually also referred to as the reinforcement chamber. This main hollow chamber is usually the hollow chamber of a hollow chamber profile that spans the greatest distance in the direction of the profile depth of the hollow chamber profile and thus in the direction of the heat transfer through the hollow chamber profile without a profile wall being present. Therefore, the insertion of an insulation element into the main hollow chamber has a very positive influence on the thermal insulation properties of the hollow chamber profile according to the invention.

It may also be advantageous if the plastic material of the hollow chamber profile is a thermoplastic. In this case, it is preferable if the plastic material of the hollow chamber profile is fiber-reinforced, in particular glass fiber-reinforced, at least in some areas of the cross-section. This contributes to the mechanical stability of the frame assembly formed from sections of the hollow chamber profile according to the invention. This is particularly important because the insulation element arranged in the hollow chamber contributes little or nothing to the statics of the hollow chamber profile and the frame assembly formed from sections of the hollow chamber profile.

The hollow chamber profile according to the invention can be advantageously manufactured by a known extrusion process. Polyvinyl chloride (PVC), in particular rigid PVC (PVC-U) or post-chlorinated PVC, is preferred as the material for the hollow chamber profile. The material may also preferably be fiber-reinforced, in particular glass fiber-reinforced. An insulation element is inserted into each of the desired hollow chambers of the hollow chamber profile. The material of the insulation element is selected so that it does not interfere with the welding of profile webs from the hollow chamber profile. During welding, the at least one insulation element is held in its desired position by the at least one positioning element. Polyvinyl chloride (PVC), in particular rigid PVC (PVC-U) or post-chlorinated PVC, polyethylene (PE), polypropylene (PP), polyethylene terephthalate (PET), acrylonitrile butadiene styrene (ABS), as well as copolymers and blends of the aforementioned polymer materials are particularly suitable as plastic materials for the metallized plastic film. The insulation elements are preferably obtained by extruding the plastic core and then coating the resulting profile with metal, in particular aluminum, silver, gold, and/or copper, on one or both sides. Any material weakening that allows the insulation elements to be geometrically adapted to the geometry of the hollow chamber into which they are to be inserted is preferably introduced into the plastic film before or after metallization. However, it may also be advantageous if the material of the insulation element comprises a thermoplastic or thermosetting plastic, paper, cardboard, or combinations of the aforementioned materials.

In preferred embodiments of the hollow chamber profile according to the invention, the at least one insulation element is designed as a plastic profile provided with a metal layer on at least one side. It is particularly preferred if the at least one insulation element is designed as a plastic profile provided with a metal layer on both sides. In this way, the thermal insulation properties of the hollow chamber profile can be further improved. The metal layer(s) may have a thickness in the range from 5 nm to 200 μm, preferably in the range from 10 nm to 25 nm. The metal layers on both sides of the plastic film may be the same or different. In addition, different insulation elements of a hollow chamber profile according to the invention may be provided with a metal layer on one side or on both sides.

In addition or as an alternative, the insulation element preferably has a material thickness of no more than 1 mm, particularly preferably in the range from 100 μm to 800 μm, especially in the range from 200 μm to 600 μm. Such a thickness of the plastic film provides sufficient stability with a significantly reduced material requirement compared to the corresponding inner webs of the hollow chamber profile.

The hollow chamber profiles according to the invention are preferably used for manufacturing a frame assembly of a plastic window or a plastic door. A window or door frame can be obtained by welding mitered pieces of a hollow chamber profile according to the invention. The resulting window or door frame is intended for installation in an opening in a wall of a building or can be installed in the opening in the wall of a building. In alternative embodiments, the present invention is also applicable to other types of profiles, for example, aluminum-plastic material composite profiles, wood-plastic material composite profiles, and the like.

The hollow chamber profile according to the invention, the frame assembly according to the invention, and individual parts thereof can also be manufactured row by row or layer by layer using a row-building or layer-building manufacturing process (e.g., 3D printing), but manufacturing by extrusion or coextrusion is preferred.

### BRIEF DESCRIPTION OF THE DRAWINGS

The present invention will now be explained in detail with reference to the embodiments shown in the figures.

FIG. 1 shows a cross-sectional view of a frame assembly according to any one embodiment of the present invention;

FIG. 2 shows a cross-sectional view of a frame assembly according to another embodiment of the present invention;

FIG. 3 shows a perspective view of an insulating element according to the hollow chamber profile of the invention shown in FIG. 2; and

FIG. 4 shows an enlarged section of the hollow chamber profile according to the invention shown in FIG. 2.

### DETAILED DESCRIPTION OF THE PREFERRED EMBODIMENTS

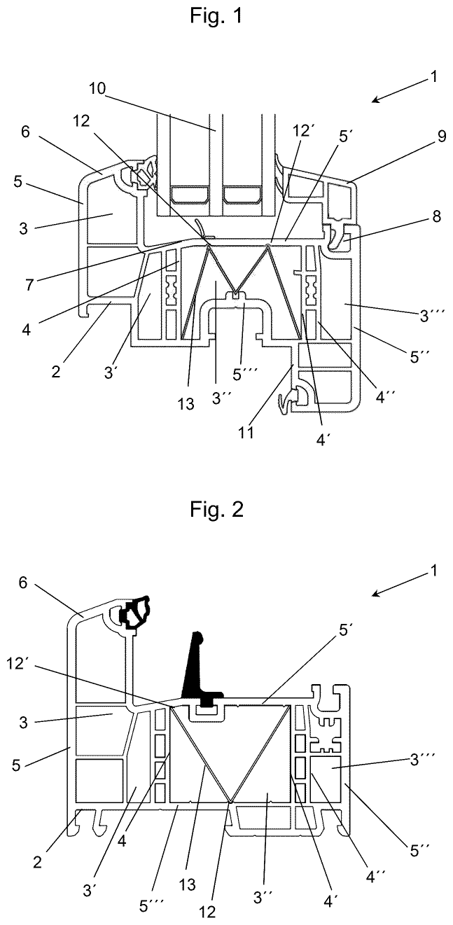

FIG. 1 shows a cross-sectional view of an embodiment of the frame assembly 1 according to the invention, wherein the frame assembly 1 is designed as a window sash. The frame assembly 1 according to the invention is constructed from profile rails of a hollow chamber profile 2 according to the invention. In the embodiment shown in FIG. 1, this is, for example, a sash profile or sash frame profile for a plastic window. The hollow chamber profile 2 is made of a thermoplastic polymer material, preferably polyvinyl chloride (PVC), in particular rigid PVC (PVC-U) or glass fiber-reinforced PVC, to which additives such as stabilizers, plasticizers, pigments, and the like are also added. It is constructed from a plurality of hollow chambers 3, 3′, 3″, 3′″, each of which is surrounded by inner walls 4, 4′, 4″ and, in some cases, also by outer walls 5, 5′, 5″, 5″″ of the hollow chamber profile 2. The hollow chamber profile 2 according to the invention has a weather-side outer wall 5 and a room-side outer wall 5″. The hollow chamber 3″ located centrally in the hollow chamber profile 2 is the main hollow chamber 3″, into which a reinforcing element, preferably steel reinforcement, can usually be inserted. In the embodiment shown, the main hollow chamber 3″ is surrounded by the inner walls 4 and 4′ and by the outer walls 5′ and 5′″.

The upper outer wall 5′ together with an outer flap 6 forms a rebate area with a rebate base 7, which extends to a glazing bead groove 8 into which a glazing bead 9 is inserted, through which the insulating glazing 10 accommodated in the rebate area is stabilized. On the room side, the hollow chamber profile 2 according to the invention is extended downwards beyond the main hollow chamber 3″ in the illustration according to FIG. 1. This profile part is referred to as a stop 11. A further groove is arranged there, which serves to accommodate a stop seal, with which a window sash formed from the hollow chamber profile 2 according to the invention rests against a frame when the window is closed. On the side of the hollow chamber 3″, the upper outer wall 5′ has two round recesses which act as positioning elements 12, 12′ for positioning an insulation element 13.

An insulation element 13 is inserted into the main hollow chamber 3″ of the hollow chamber profile 2 according to the invention. In the embodiment shown in FIG. 1, the insulation element 13 is designed as a plastic profile 13 coated on both sides with a metal layer. The plastic profile 13 has a thickness of 450 μm, with the metal layers on both sides of the plastic profile 13 being made of aluminum and each having a thickness of 40 nm. On both sides, the coating of the insulation element 13 has a plurality of interruptions, which in the embodiment shown in FIG. 1 are formed as perforations in the coating on the two metallized surfaces of the insulation element 13. The perforations in the coating each have a diameter of 0.3 mm and are present in a number of 15 perforations per cm² on both sides of the coating. The perforations interrupt the heat flow along the coating, reducing its thermal conductivity, in particular its lateral thermal conductivity. As a result, the hollow chamber profile 2 according to the invention has a reduced overall thermal conductivity.

In the embodiment shown in FIG. 1, the plastic profile 13 metallized on both sides has an essentially M-shaped cross-section. The plastic portion of the plastic profile metallized on both sides is made of polyvinyl chloride (PVC). The plastic profile 13 metallized on both sides is inserted into the main hollow chamber 3″ of the hollow chamber profile 2 according to the invention. To this end, the plastic profile 13 metallized on both sides is attached to an open side of the hollow chamber profile 2 in such a way that the two tips of the M-shaped cross-section penetrate into the two positioning elements 12, 12′. The other edges of the insulating element 13 are guided into the lower corners of the main hollow chamber 3″ shown in FIG. 1 and into a screw guide of a fitting groove of the hollow chamber profile 2 according to the invention. The plastic profile 13 can then be inserted into the hollow chamber profile 2 along its entire length. The two tips of the M-shaped cross-section of the plastic profile 13 protrude into the two positioning elements 12, 12′, which makes it easy to insert the plastic profile 13. On the opposite side, the plastic profile 13 rests against the outer wall 5″ of the hollow chamber profile 2. This ensures the positional stability of the plastic profile 13 in the main hollow chamber 3″ of the hollow chamber profile 2 according to the invention, whereby the thermal insulation properties of the hollow chamber profile 2 according to the invention are maintained at a high level even over a longer period of time.

FIGS. 2 to 4 show further embodiments of the present invention. To avoid repetition, only differences from the embodiment of the present invention shown in FIG. 1 are described below. The explanations for FIG. 1 also apply to the embodiment according to FIGS. 2 to 4. Identical elements are marked with identical reference numerals in the figures.

FIG. 2 shows a further embodiment of the frame assembly 1 according to the invention, which is designed as a blind frame, in a cross-sectional view. The frame assembly 1 according to the invention is constructed from profile rails of the hollow chamber profile 2 according to the invention. In the embodiment shown in FIG. 1, this is, for example, a blind frame profile for a plastic window.

In the embodiment shown in FIG. 2, the main hollow chamber 3″ of the hollow chamber profile 2 is surrounded by the inner walls 4, 4′ and the outer walls 5′, 5′″. In accordance with the embodiment shown in FIG. 2, an insulation element 13 is also inserted into the main hollow chamber 3″.

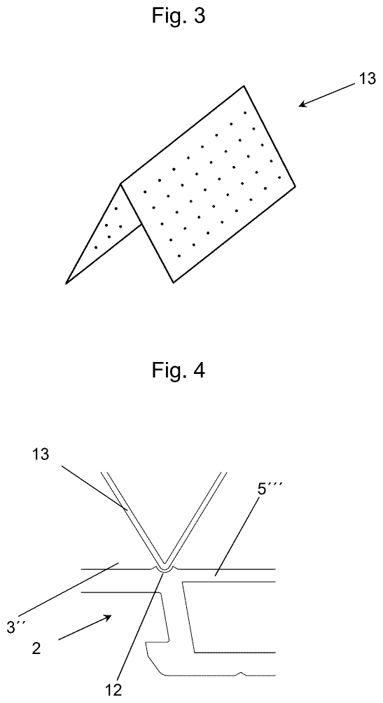

The insulation element 13 according to the embodiment shown in FIG. 2 is shown in FIG. 3 in a perspective view. The insulation element 13 is again designed as a plastic profile 13 coated with a metal layer on both sides. In this embodiment, the plastic profile 13 is designed as a two-sided angle profile, with the two sides forming an angle of approximately 50°. The plastic profile 13 has a thickness of 480 μm, with the metal layers on both sides of the plastic profile 13 being made of copper and each having a thickness of 45 nm. The shape of the plastic profile 13 is adapted to the cross-section of the main hollow chamber 3″, with the plastic profile 13 having an essentially V-shaped cross-section. The plastic portion of the plastic profile metallized on both sides is formed from acrylonitrile butadiene styrene (ABS). As can be clearly seen in FIG. 3, the coating of the insulation element 13 has a plurality of interruptions, which in the embodiment shown in FIG. 1 are formed as perforations in the coating on both metallized surfaces of the insulation element 13, penetrating the insulation element 13. The perforations in the coating each have a diameter of 0.4 mm and are present in a number of 20 perforations per cm² on both sides of the coating. The perforations interrupt the heat flow along the coating, reducing its thermal conductivity, in particular its lateral thermal conductivity. As a result, the hollow chamber profile 2 according to the invention has a reduced overall thermal conductivity.

The plastic profile 13, which is metallized on both sides, is arranged in the illustration according to FIG. 2 with its tip pointing downwards in the main hollow chamber 3′ of the hollow chamber profile 2. The tip of the plastic profile 13 rests in a positioning element 12, which is designed as a recess or notch and is inserted into a raised area of the outer wall 5″″ of the hollow chamber profile 2. This is shown in the enlarged cross-sectional view according to FIG. 4.

The two spaced-apart edges of the V-shaped cross-section of the plastic profile 13 rest on the opposite profile wall 5′. A positioning element 12′ in the form of a recess is incorporated into the outer wall 5′. One end of the plastic profile 13 is guided in this positioning element 12′.

The plastic profile 13, which is metallized on both sides, is in turn inserted into the main hollow chamber 3″ of the hollow chamber profile 2 according to the invention. For this purpose, the plastic profile 13, which is metallized on both sides, is placed on an open side of the hollow chamber profile 2 in such a way that the tip of the V-shaped cross-section penetrates into the positioning element 12. One of the two spaced-apart ends of the plastic profile 13 rests against the positioning element 12′. The plastic profile 13 can then be inserted into the hollow chamber profile 2 along its entire length. The tip of the V-shaped cross-section of the plastic profile 13 protrudes into the positioning element 12, whereby the plastic profile is additionally guided by the end in the positioning element 12′. This facilitates the insertion of the plastic profile 13 into the hollow chamber 3″ with high positioning accuracy. This ensures the positional stability of the plastic profile 13 in the main hollow chamber 3″ of the hollow chamber profile 2 according to the invention, whereby the thermal insulation properties of the hollow chamber profile 2 according to the invention are maintained at a high level even over a longer period of time.

In the embodiment shown, the plastic profile 13 is in contact with two opposite walls of the respective hollow chamber in a positionally stable manner.

The present invention has been described by way of example with reference to sash frame and casement frame profiles of a window. It is understood that the present invention is also applicable to other hollow chamber profiles, in particular face plate, post, and blind post profiles, as well as frame, casing, or sash frame profiles of a door. The embodiments also apply accordingly to other types of sash and frame profiles, for example, aluminum-plastic composite profiles, wood-plastic composite profiles, and the like. It is therefore understood that the present invention is not limited to these exemplary embodiments, but that the scope of the present invention is defined by the claims.

1. Hollow chamber profile for a window or door made of plastic material, wherein the plastic material forms the inner walls and the outer walls of the hollow chamber profile, wherein the inner walls and the outer walls surround the hollow chambers of the hollow chamber profile, wherein at least one insulation element designed as a plastic profile is inserted into at least one of the hollow chambers of the hollow chamber profile, the surface of which is provided at least in some areas with a coating designed as a low-emission metal layer, wherein the coating of the insulation element comprises a plurality of interruptions.

2. Hollow chamber profile according to claim 1, wherein the interruptions are formed as perforations in the coating of the insulation element.

3. Hollow chamber profile according to claim 2, wherein the perforations in the coating have a diameter within a range of 0.05 mm to 0.8 mm.

4. Hollow chamber profile according to claim 2, wherein the coating comprises perforations at a frequency within a range of 2 to 30 per cm² of the coating.

5. Hollow chamber profile according to claim 1, wherein the interruptions in the coating are generated by laser perforation or partial coating.

6. Hollow chamber profile according to claim 1, wherein at least one of the inner walls or the outer walls of the hollow chamber, into which the at least one insulation element is inserted, comprises at least one positioning element for positioning the at least one insulation element.

7. Hollow chamber profile according to claim 6, wherein the hollow chamber profile comprises at least two positioning elements which are arranged on two opposite walls of the hollow chamber in which the at least one insulation element is accommodated.

8. Hollow chamber profile according to claim 1, wherein in that the plastic profile has a material thickness of no more than 1 mm, preferably in a range from 100 μm to 800 μm, in particular in a range from 200 μm to 600 μm.

9. Frame assembly for a window or door, comprising at least one profile section of a hollow chamber profile according to claim 1.
